(19) United States
(12) Patent Application Publication
(10) Pub. No.: US 2015/0360244 A1
(43) Pub. Date: Dec. 17, 2015

(54) Compost Wetting Device

(71) Applicant: Cameron Scheelhaase, Regina (CA)

(72) Inventor: Cameron Scheelhaase, Regina (CA)

(21) Appl. No.: 14/538,070

(22) Filed: Nov. 11, 2014

Related U.S. Application Data
(60) Provisional application No. 62/011,142, filed on Jun. 12, 2014.

(51) Int. Cl. B05B 1/20; B05B 1/30

(52) U.S. Cl. CPC B05B 1/20; B05B 1/3013

(57) ABSTRACT

A compost wetting device for use with a garden hose or similar water source. The compost wetting device includes an elongated tubular member having an open first end and a closed second end. The elongated tubular member includes a plurality of apertures thereon through which water can pass. The first end includes a handle assembly having a tubular construction. The handle assembly can be connected to a garden hose to provide water to the elongated tubular member. The handle assembly includes a valve that is opened or closed by means of a trigger disposed on the handle assembly. This allows the user to control the flow of water through the compost wetting device. In operation, a user can insert the elongated tubular member into a compost pile and engage the trigger to cause water to escape through the apertures on the elongated tubular member to water and aerate the compost.

### CROSS REFERENCE TO RELATED APPLICATION

This application claims the benefit of U.S. Provisional Application No. 62/011,142 filed on Jun. 12, 2014. The above identified patent application is herein incorporated by reference in its entirety to provide continuity of disclosure.

### BACKGROUND OF THE INVENTION

2. Field of the Invention

The present invention relates to a compost wetting device. More specifically, the present invention provides an elongated tubular member having a plurality of apertures thereon through which water may pass, wherein said elongated tubular member can be connected to a water source, such as a garden hose, so that water can flow therethrough. The device further includes a valve operated by a trigger so that a user may control the flow of water through the elongated tubular member.

Compost piles are commonly used to decompose organic matter such as leaves and food waste in order to produce a nutrient rich growing medium that can be added to soil. Compost can help to improve the fertility of soil and is commonly used in gardens, landscaping, and for agricultural purposes. As compost decomposes over an extended period of time, it must be periodically watered and aerated in order to ensure proper decomposition of all of the material within the compost heap. Otherwise, the compost heap may decompose unevenly and may serve as a breeding ground for insects and other pests.

However, watering and aerating compost can be a difficult and time consuming activity. A user must manually mix water into the compost so that all of the compost is wetted. The user must periodically water and aerate the compost, resulting in much time spent monitoring and tending to the compost heap. Thus, a device that allows a user to more easily water and aerate a compost heap is desired.

The present invention provides a compost wetting device for use with a hose. The compost wetting device comprises an elongated tubular member having an open first end and a closed second end. The first end includes a handle assembly comprising a valve, wherein the handle assembly can be removably secured to a garden hose so that the elongated tubular member is in fluid communication with the garden hose. The valve can be opened or closed by a trigger on the exterior of the handle assembly that allows the user to control the flow of water into the tubular member. The elongated tubular member includes a plurality of apertures thereon so that the liquid therein can escape the tubular member at various points along the length of the tubular member. In this way, the user can insert the elongated tubular member into a pile of compost and can open the valve to allow water to flow outward from the tubular member and into the compost heap.

2. Description of the Prior Art

Devices have been disclosed in the prior art that relate to composting devices. These include devices that have been patented and published in patent application publications. These devices generally relate to compost containers and bins having means for stirring or aerating the compost held therein. The following is a list of devices deemed most relevant to the present disclosure, which are herein described for the purposes of highlighting and differentiating the unique aspects of the present invention, and further highlighting the drawbacks existing in the prior art.

One such device, U.S. Pat. No. 5,433,524 to Wiister discloses a compost container having a stirring mechanism. The device includes a chamber in which compost can be positioned and a stirring mechanism. The stirring mechanism is operated via an external shaft that controls a stirring element disposed within the container. Thus, Wiister discloses a container having a stirring element and does not disclose an elongated tubular member having a plurality of apertures, wherein the tubular member can be removably secured to a garden hose or similar water source.

U.S. Pat. No. 6,482,627 to Dahlstrom discloses a composting device having an aeration tube. The composting device comprises a container having baffles and an aeration port. The aeration tube includes a screen and extends from the aeration port into the interior of the container. Air can enter the aeration port and flow into the hollow interior of the aeration tube and outward through openings thereon. Thus, Dahlstrom fails to disclose an elongated tubular member that can be connected to a water source for distributing water to a compost heap.

U.S. Pat. No. 8,129,177 to Cohn discloses a composting system for rapid composting. The device includes an air-tight housing that is thermally insulated. A mixing wand mechanically mixes the compost and enhances air flow. A motor provides mixing and an electronic controller automates the composting process. Thus, Cohn discloses a motorized composting device having multiple chambers and does not disclose an elongated tubular member attachable to a garden hose for distributing water to a compost pile.

U.S. Pat. No. 5,766,876 to Santiago et al. discloses a compost bin. The bin has an interior volume in which compost can be stored and includes apertures formed into the walls of thereof. A plurality of ventilation tubes extend through the apertures. A cross tube connects the ventilation tubes and has a down-turned portion having a bio-filter bag thereon. Gases that escape the bin through the ventilation tubes are filtered through the bio-filter bag. Thus, Santiago fails to disclose an elongated tubular member securable to a garden hose, wherein the elongated tubular member includes apertures thereon for distributing water into a compost heap.

U.S. Pat. No. 5,744,351 to Bryan-Brown discloses a bioreactor for composting organic waste. The bioreactor includes a container, a lid cover, a mixing assembly mounted on the lid cover, and an aeration system. The mixing assembly is mounted on a slide system that permits a mixing auger to move radially within the container. Thus, Bryan-Brown discloses a bioreactor and does not disclose a compost wetting device attachable to a garden hose or similar water source.

Finally, U.S. Pat. No. 4,687,645 to Harvey discloses a composting unit for rapidly composting waste. The device includes a rotating drum mounted on a horizontal transverse axis. The device further includes a perforated tube for aerating the compost within the drum. Thus, Harvey provides a device for holding compost that permits aeration of the compost and does not disclose an elongated tubular member having a handle assembly and that is attachable to a garden hose.

These prior art devices have several known drawbacks. Devices in the prior art generally relate to containers for holding compost that allow for stirring or aeration of the compost. Such devices do not provide means for wetting the compost. Further, the present invention provides a device for use with any compost pile held within any type of container. The user can insert the elongated tubular member into the compost pile and can allow water to flow therethrough and outward from the apertures on the tubular member in order to distribute water to various portions of the compost pile.

In light of the devices disclosed in the prior art, it is submitted that the present invention substantially diverges in design elements from the prior art and consequently it is clear that there is a need in the art for an improvement to existing compost wetting and mixing devices. In this regard the instant invention substantially fulfills these needs.

### SUMMARY OF THE INVENTION

In view of the foregoing disadvantages inherent in the known types of composting devices now present in the prior art, the present invention provides a new compost wetting device wherein the same can be utilized for providing convenience for the user when wetting and aerating a pile of compost to encourage proper decomposition of the compost pile.

It is therefore an object of the present invention to provide a new and improved compost wetting device that has all of the advantages of the prior art and none of the disadvantages.

It is another object of the present invention to provide a compost wetting device comprising an elongated tubular member having a plurality of apertures that is connectable to a conventional garden hose or similar water source.

Another object of the present invention is to provide a compost wetting device having an elongated tubular member with a plurality of spaced apertures for simultaneously distributing water to various portions of a compost pile.

Yet another object of the present invention is to provide a compost wetting device having a handle assembly with a trigger thereon for opening and closing a valve that controls the flow of water through the handle assembly.

Another object of the present invention is to provide a compost wetting device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the compost wetting device of the present invention.

FIG. 2 shows a perspective view of the compost wetting device of the present invention in use.

FIG. 3 shows a cross sectional view of the compost wetting device of the present invention.

### DETAILED DESCRIPTION OF THE INVENTION

Reference is made herein to the attached drawings. Like reference numerals are used throughout the drawings to depict like or similar elements of the compost wetting device. For the purposes of presenting a brief and clear description of the present invention, the preferred embodiment will be discussed as used for wetting and aerating a compost heap. The figures are intended for representative purposes only and should not be considered to be limiting in any respect.

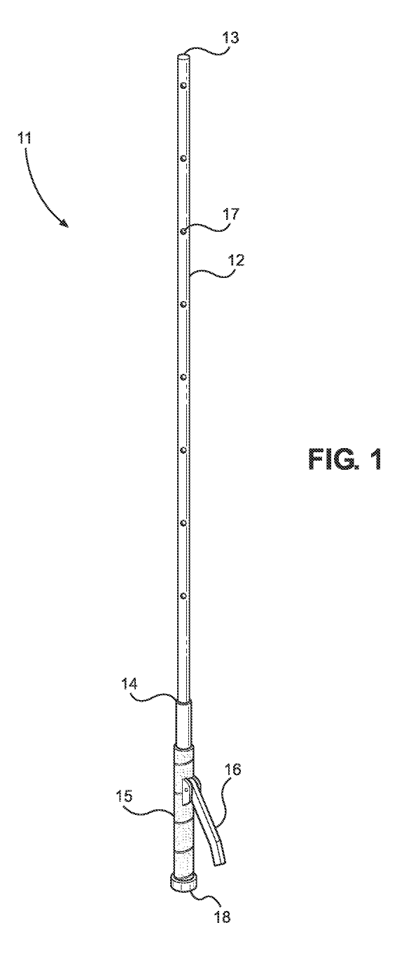

Referring now to FIG. 1, there is shown a perspective view of an embodiment of the compost wetting device of the present invention. The present invention provides a compost wetting device 11 comprising an elongated tubular member 12 having a first end 14 that is open, a second end 13 that is closed, and a hollow interior volume. The elongated tubular member 12 is preferably linear and is more preferably cylindrical in shape. The elongated tubular member 12 is composed of a durable, rigid material that is corrosion-resistant.

The elongated tubular member 12 includes a plurality of apertures 17 along the length thereof. In this way, water that flows through the elongated tubular member 12 can escape the tubular member 12 through the various apertures 17. This allows a user to distribute water to various portions of a compost pile simultaneously without having to stir or mix the compost pile. The apertures 17 are preferably spaced at a fixed interval along the length of the elongated tubular member 12. Further, the apertures are preferably arranged linearly in a row along the elongated tubular member 12. In some embodiments, the apertures 17 are arranged in pairs on opposing sides of the elongated tubular member 12. In this way, water can escape the tubular member 12 on the left side and right side thereof.

The first end 14 of the elongated tubular member comprises a handle assembly 15 thereon that the user can hold while operating the compost wetting device 11. The handle assembly 15 is tubular and includes a hollow interior volume so that fluid may pass therethrough. The handle assembly 15 includes a valve that can be opened or closed by the user so as to control the flow of water within the interior volume of the handle assembly 15. The valve is preferably controlled by a hand-operated trigger 16 pivotally disposed on the handle assembly 15. In some embodiments, the valve responds to the positioning of the trigger 16 so that the flow rate of the water increases as the trigger 16 is further depressed. In other embodiments, the trigger 16 simply opens or closes the valve. The handle assembly 15 may optionally include padding or cushioning thereon to provide comfort to the user while holding the compost wetting device 11.

The handle assembly 15 includes an opening 18 at the lower end thereof for connection to a water source, such as a garden hose. Preferably the opening 18 is threaded so as to engage the threaded end of a hose. Thus, by engaging a hose with the opening 18 of the handle assembly 15, the liquid in the hose can pass through the handle assembly 15 and into the elongated tubular member 12.

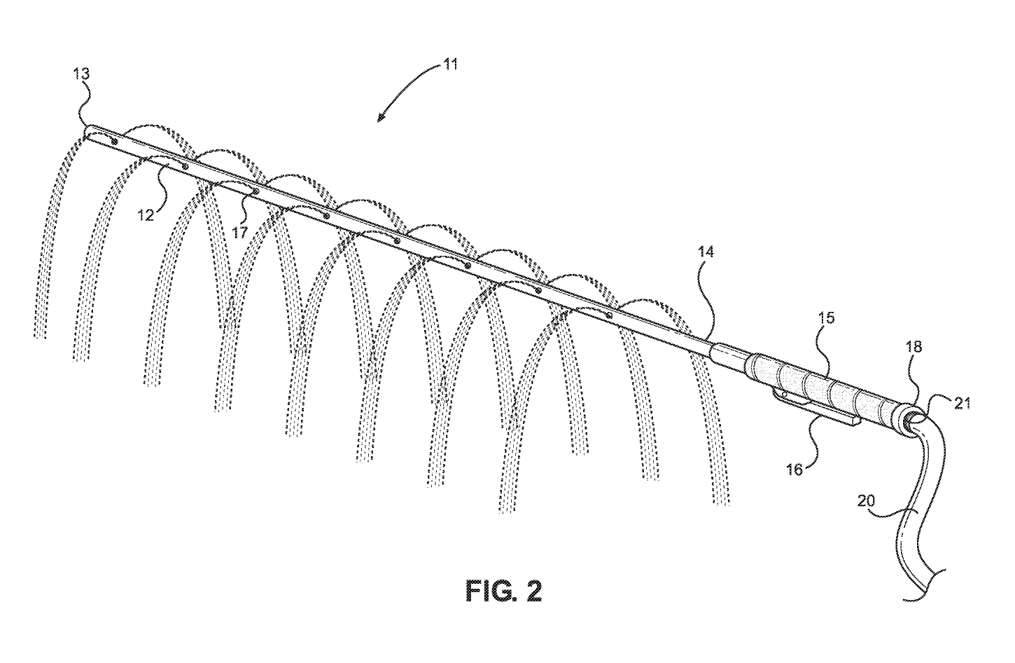

Referring now to FIG. 2, there is shown a perspective view of the compost wetting device of the present invention in use. In operation, the user may secure the end 21 of a garden hose 20 to the opening 18 of the handle assembly 15. The threading of the garden hose 20 can be engaged with the threaded opening 18 so as to removably secure the garden hose 20 to the compost wetting device 11.

In operation, the user can hold the device by the handle assembly 15 and can insert the elongated tubular member 12 into a pile of compost. The user can insert the tubular member 12 into the compost pile in a vertical orientation, a horizontal orientation, or at an angle. Water supplied by the hose 20 flows into the handle assembly 15. The user can hold the handle assembly 15 and depress the trigger 16 against the handle assembly 15 in order to open the valve therein, allowing water to flow through the handle assembly 15 and into the elongated tubular member 12. As water flows through the first end 14 of the tubular member 12 towards the second end 13 thereof, it escapes through the apertures 17 thereon. The water passes through multiple apertures 17 simultaneously, so that a user can wet various portions of a pile of compost in order to wet the entire pile. The user can insert the tubular member 12 into various portions of the compost pile in order to evenly wet the entire compost pile. The indentation in the pile made by the tubular member 12 may also help to aerate the compost pile.

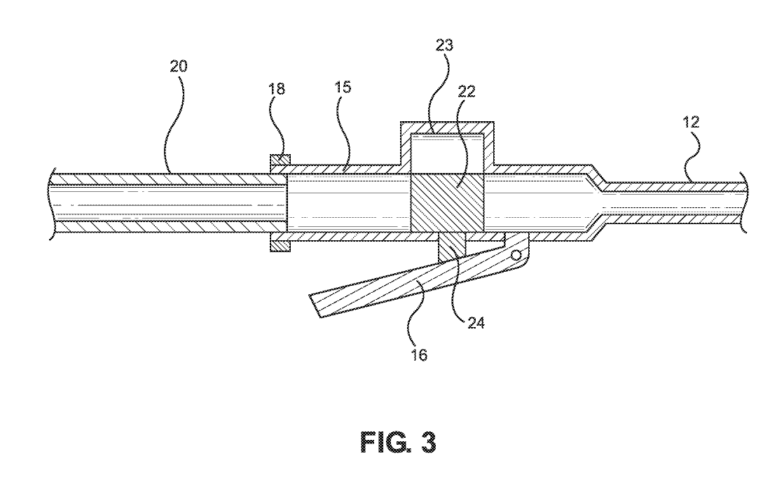

Referring now to FIG. 3, there is shown a cross sectional view of the compost wetting device of the present invention. The elongated tubular member 12 includes a handle assembly 15 thereon. The opening 18 on the handle assembly 15 can be removably secured to a garden hose 20 or other similar water source so as to provide water to the device. The handle assembly 15 comprises a hollow interior volume so that water can flow therethrough. The handle assembly 15 further includes a valve 22 that allows or prevents water from flowing therethrough. The valve 22 is operated via the trigger 16 on the exterior of the handle assembly 15. Thus, the user can operate the trigger 16 in order to allow water to flow through the handle assembly 15, or to prevent the flow of water therethrough.

In the illustrated embodiment, the trigger 16 is connected to a valve 22 by a linkage 24. The valve 22 includes a stopper that prevents water from flowing through the handle assembly 15 when the trigger is in a resting position. When the trigger 16 is depressed towards the handle assembly 15, the stopper of the valve 22 is moved into a recess 23 on the handle assembly, creating an opening in the interior volume of the handle assembly 15 so that water may flow therethrough. Various types of valves may be used that are suitable for allowing the user to selectively allow water to flow through the handle assembly 15 and in to the elongated tubular member 12.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A compost wetting device, comprising:
an elongated tubular member having a hollow interior volume, a first end that is open, and a second end that is closed;
wherein said elongated tubular member includes a plurality of apertures thereon;
a handle assembly disposed on said first end, wherein said handle assembly comprises a hollow interior volume adapted to allow liquid to flow therethrough;
an opening on said handle assembly adapted to receive an end of a hose;
a trigger disposed on said handle assembly adapted to allow a user to control the flow of water through said handle assembly and through said elongated tubular member.

2) The compost wetting device of claim 1, wherein said plurality of apertures are spaced at a fixed interval along the length of said elongated tubular member.

3) The compost wetting device of claim 1, wherein said plurality of apertures are arranged on opposing sides of said elongated tubular member.

4) The compost wetting device of claim 1, wherein said elongated tubular member is substantially linear.

5) The compost wetting device of claim 1, wherein said opening on said handle assembly is threaded.

6) The compost wetting device of claim 1, wherein said trigger is adapted to open or close a valve within said handle assembly to control the flow rate of water through said handle assembly.
